(19) United States
(12) Patent Application Publication
(10) Pub. No.: US 2024/0253312 A1
(43) Pub. Date: Aug. 1, 2024

(54) DYNAMIC SPLITTING AND MOVEMENT FOR 3D PRINTING

(71) Applicant: INTERNATIONAL BUSINESS MACHINES CORPORATION, ARMONK, NY (US)

(72) Inventors: Jeremy R. Fox, Georgetown, TX (US); Randy A. Rendahl, Raleigh, NC (US); Mauro Marzorati, Lutz, FL (US); Sarbajit K. Rakshit, Kolkata (IN)

(21) Appl. No.: 18/161,913

(22) Filed: Jan. 31, 2023

(51) Int. Cl. B29C 64/393; B29C 64/182; B29C 64/209

(52) U.S. Cl. CPC B29C 64/393; B29C 64/182; B29C 64/209; B33Y 10/00; B33Y 50/02

(57) ABSTRACT

According to one embodiment, a method, computer system, and computer program product for 3D printing is provided. The present invention may include arranging and manipulating an array of wheels on a baseplate; analyzing shape and/or dimensions of an object to be 3D printed; determining an arrangement of one or more blocks on which to print the object to be 3D printed based on the analyzing of the shape and/or dimensions of the object to be 3D printed; positioning, using the array of wheels, the one or more blocks into the determined arrangement; and printing the object to be 3D printed onto the one or more arranged blocks.

### BACKGROUND

The present invention relates, generally, to the field of computing, and more particularly to 3D Printing.

3D printing is a technology that is used to construct a three-dimensional object (3D object) from a digital 3D model. 3D printing is performed in processes in which material is deposited, and joined or solidified under computer control, with material typically being added together layer by layer. Currently, 3D printing can be performed on various pre-assembled parts, which can either be assembled or reused in the manufacturing process, thus, accelerating the 3D printing process. However, in order for true optimization of the 3D printing process, a method and system by which pre-assembled parts can be arranged properly during the 3D printing process so that the 3D printing is performed effectively are needed. Thus, an improvement in 3D printing has the potential to benefit a user, the 3D printing process, and 3D printed products by reducing waste and optimizing printing time.

### SUMMARY

According to one embodiment, a method, computer system, and computer program product for 3D printing is provided. The present invention may include arranging and manipulating an array of wheels on a baseplate; analyzing shape and/or dimensions of an object to be 3D printed; determining an arrangement of one or more blocks on which to print the object to be 3D printed based on the analyzing of the shape and/or dimensions of the object to be 3D printed; positioning, using the array of wheels, the one or more blocks into the determined arrangement; and printing the object to be 3D printed onto the one or more arranged blocks.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application invention environment according to at least one embodiment;

FIG. 3 is an operational flowchart illustrating a 3D printing splitting and movement determination process according to at least one embodiment;

FIG. 4 is an operational flowchart illustrating a 3D printing process according to at least one embodiment;

FIG. 5 is a system diagram illustrating an exemplary program environment of an implementation of a 3D printing splitting and movement determination process according to at least one embodiment; and

FIG. 6 depicts a visual representation of a baseplate with multiple 3D printing nozzles according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may however, be embodied in many different forms and should not be construed as limited to the exemplary embodiments set forth herein. In the description, details of well-known features and techniques may be omitted to avoid unnecessarily obscuring the presented embodiments.

In 3D printing, a 3D object may either be printed starting from scratch or by assembling various pre-manufactured parts. Additionally, if various pre-manufactured parts are used, a 3D object can be created by performing additional printing on the various pre-manufactured parts, either separately or once the parts are assembled into a unified 3D printed object. If a person decides to use various pre-manufactured parts while 3D printing, the person must manually move the parts into position and assemble the blocks themselves, for example, by stacking the parts or connecting them together. Additionally, a person may wish to make modifications to an object being 3D printed during the printing process and thus, have to subsequently reprint the object numerous times, leading to the user wasting expensive materials and spending a lengthy amount of their time printing the object. Therefore, it may be likely that the 3D printing process optimization is limited because of the need to manually interrupt the 3D printing process and/or to restart the printing process, thus, prolonging the process.

One way in which current methods attempt to address problems with creating 3D objects using pre-manufactured and/or reusable parts is through the use of a conveyor belt during the 3D printing process. The use of a conveyor belt during 3D printing allows for the printing of multiple 3D objects because the conveyor belt can clear the printing area by moving 3D printed objects away from the printing area after they are printed. However, several deficiencies exist in the current method. One of the deficiencies of the current method is that only a single printing nozzle can be used, allowing for only one filament to be used during the printing process. Another deficiency of the current method is that using a conveyor belt still requires manual labor to assemble several pre-manufactured parts into one unit if the 3D printed product is not completed after the addition of a single filament. Thus, an improvement in 3D printing has the potential to improve the efficiency and cost of 3D printing and additionally lessen the manual labor of a person performing 3D printing, thus, benefitting the user, the 3D printing process, and the 3D printed product.

The present invention has the capacity to improve 3D printing by dynamically rearranging pre-manufactured blocks to print a 3D object based on the design of the 3D object. The present invention can analyze digital 3D models of a 3D object and determine how to properly arrange pre-manufactured parts using an array of wheels so that 3D printing can be performed on the parts. This improvement in 3D printing can be accomplished by implementing a system that provides a baseplate with an array of wheels, analyzes the shape and/or dimensions of an object to be 3D printed, determines an arrangement of one or more blocks on which to print the object to be 3D printed based on the analyzing of the shape and/or dimensions of the object to be 3D printed, and positions, using the array of wheels, the one or more bocks into the determined arrangement; and printing a 3D object onto the one or more arranged blocks.

In some embodiments of the invention, the 3D printing splitting and movement determination program, herein referred to as “the program”, can arrange and manipulate an array of wheels on a baseplate. The program can move 3D printed objects and/or parts of a 3D printed object on the 3D printing baseplate using the array of wheels. The program can dynamically control the speed and direction of each wheel. Based on the required workflow of the 3D printing, the required number of 3D printing nozzles may take appropriate positions over the 3D printing baseplate to perform 3D printing.

The program can analyze a digital model, such as a CAD file, of the 3D object to be printed, also referred to as a “3D object”, and may select appropriate pre-manufactured blocks to use to print the 3D object based on the shape and dimensions of the 3D object. The program can comprise an inventory of the available pre-manufactured blocks that may be used and the shape and dimensions of the available blocks. The program can identify various blocks that are available to use and if the blocks can be used to print the 3D object. The program can identify the progress of 3D printing and may identify when a pre-manufactured block needs to be moved to a different position on the 3D printing baseplate. The array of wheels implemented into the 3D printing baseplate can rearrange pre-manufactured blocks. The program may properly rearrange the pre-manufactured blocks as per the required design of the 3D printed object.

The program can use multiple 3D printers and/or 3D printing nozzles to print a 3D object. More than one 3D printer and/or 3D printing nozzle may share a common baseplate and may be attached to the baseplate at different positions. Multiple 3D printing nozzles may be used to print various materials through the use of different filaments loaded into each nozzle. Multiple 3D printers and/or 3D printing nozzles may be used to print at the same or different times, allowing for a parallel printing ecosystem. The program can analyze a digital model of a 3D object to be printed and may identify if the 3D object may be printed in parts by using more than one 3D printer. The program may perform a digital twin simulation to determine if the 3D object may be printed in multiple parts and put together when all the parts of the 3D object are printed. Additionally, multiple 3D printers can be used to print the 3D object if more than one filament is being used to print the 3D object. If the 3D object may be printed using more than one 3D printer, the program can split the 3D object into separate parts to be printed, and assign the printing of each part, to any of the 3D printers. The program can assign certain blocks to use for each printing job.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to arrange and manipulate an array of wheels on a baseplate, analyze the shape and/or dimensions of an object to be 3D printed; determine an arrangement of one or more blocks on which to print the object to be 3D printed based on the analyzing of the shape and/or dimensions of the object to be 3D printed, position, using the array of wheels, the one or more blocks into the determined arrangement, and print the object to be 3D printed onto the one or more arranged blocks.

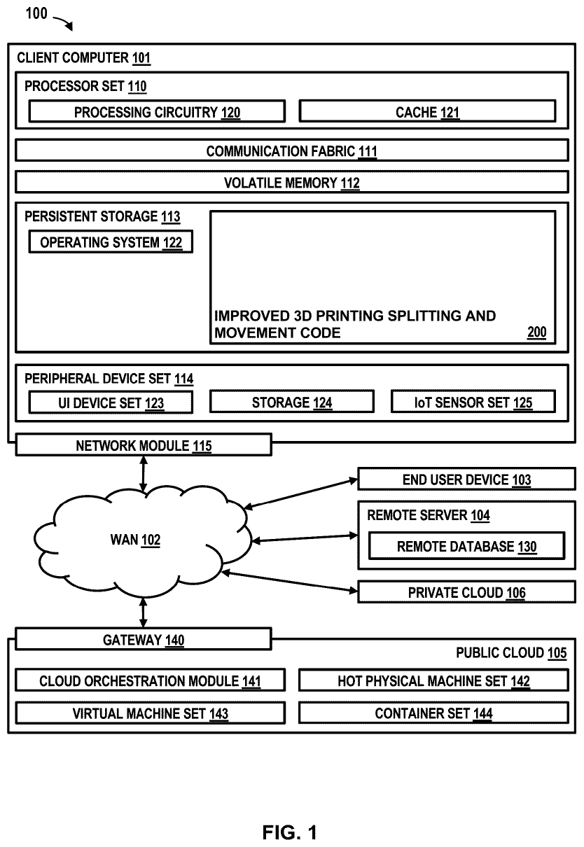

Referring to FIG. 1, an exemplary networked computer environment 100 is depicted, according to at least one embodiment. Computing environment 100 contains an example of an environment for the execution of at least some of the computer code involved in performing the inventive methods, such as improved 3D printing splitting and movement code 200. In addition to code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

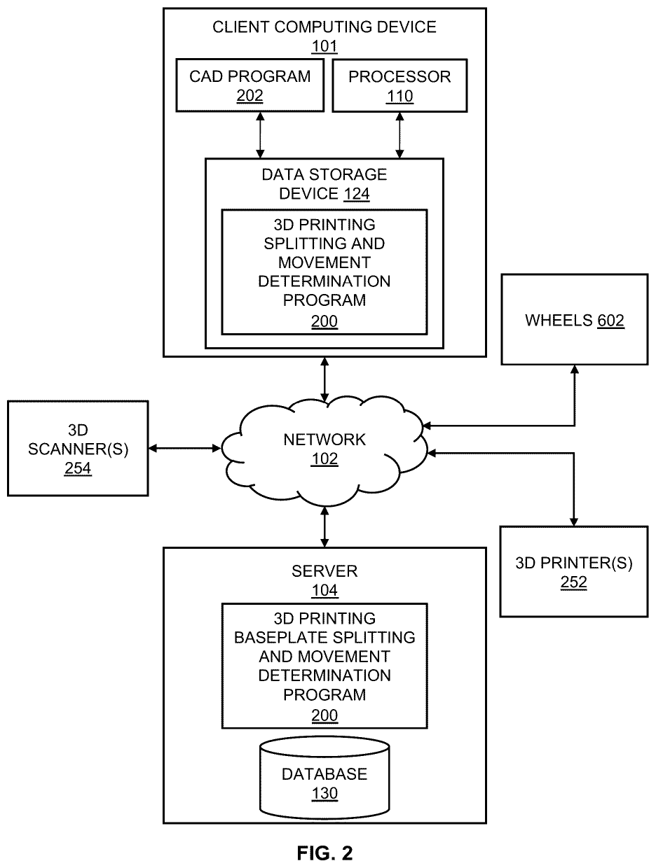

Referring to FIG. 2, an exemplary application environment is depicted, according to at least one embodiment. FIG. 2 may include client computing device 101 and a remote server 104 interconnected via a communication network 102. According to at least one implementation, FIG. 2 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run a 3D printing splitting and movement determination program 200 and communicate with the remote server 104 via the communication network 102, in accordance with one embodiment of the invention. Client computing device 101 may include a computer-aided design (CAD) program 202. CAD program 202 can be any program capable of creating two-dimensional drawings and/or three-dimensional models.

The remote server computer 104 may be a laptop computer, netbook computer, personal computer (PC), a desktop computer, or any programmable electronic device or any network of programmable electronic devices capable of hosting and running a 3D splitting and movement determination program 200 and a database 130 and communicating with the client computing device 101 via the communication network 102, in accordance with embodiments of the invention. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 130 can store 3D digital models and the information outputted from the CAD module 508. The database 130 may store information relating to object recognition. The database 130 may comprise the printing inventory system. The printing inventory system may comprise the inventory of pre-manufactured blocks 604 available for the 3D printer 252 to use.

3D printer 252 may be any device capable of constructing a 3D object from a CAD model or other digital 3D model. Additionally, the 3D printer 252 may comprise one or more cameras embedded into the 3D printer 252.

3D scanner 254 may be any device capable of scanning a 3D object. The 3D scanner 254 may determine the printing progress of a 3D object using object recognition and may determine the relative positioning of the 3D object on the baseplate 610. Additionally, the 3D scanner 254 may comprise one or more cameras embedded into the 3D printer 252.

The baseplate 610 can contain an array of wheels 602. The array of wheels 602 may be a spherical shape, such that the wheels 602 can rotate in any direction and such that an object placed on the baseplate 610 may glide along the baseplate 610. The array of wheels 602 may also be disk-shaped. The program 200 can control the speed and direction of the array of wheels 602. Each wheel 602 may be individually controllable for speed and direction. The array of wheels 602 may also raise or lower. The program 200 may communicate with the array of wheels 602 either wired and/or wirelessly and/or optically

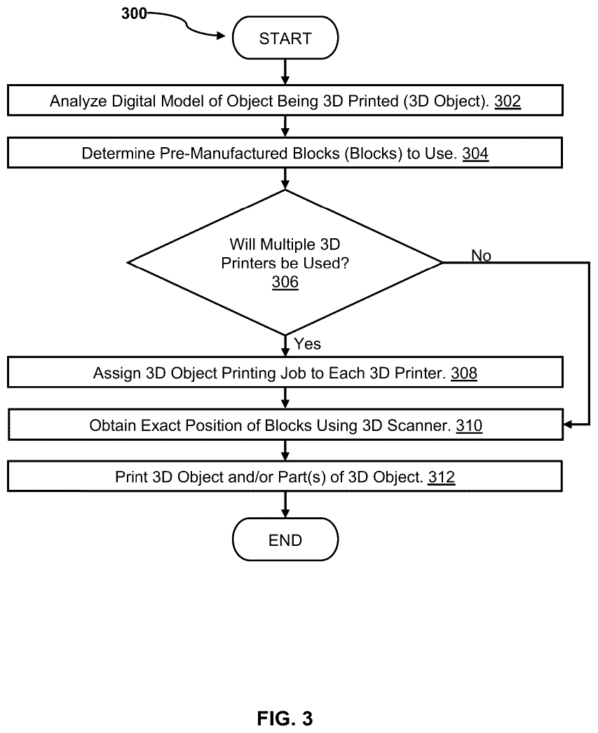

According to the present embodiment, the 3D printing splitting and movement determination program 200 may be a program capable of arranging and manipulating an array of wheels on a baseplate, analyzing the shape and/or dimensions of an object to be 3D printed, determining an arrangement of one or more blocks 604 on which to print the object to be 3D printed based on the analyzing of the shape and/or dimensions of the object to be 3D printed, positioning, using the array of wheels, the one or more blocks 604 into the determined arrangement, and printing the object to be 3D printed onto the one or more arranged blocks 604. The program 200 may be located on client computing device 101 or remote server 104 or on any other device located within network 102. Furthermore, the program 200 may be distributed in its operation over multiple devices, such as client computing device 101 and remote server 104. The 3D printing splitting and movement determination method is explained in further detail below with respect to FIG. 3.

Referring now to FIG. 3, an operational flowchart illustrating a 3D printing splitting and movement determination process 300 is depicted according to at least one embodiment. At 302, the program 200 analyzes a digital model of an object being 3D printed, herein referred to as “3D object”. The program 200 can analyze a CAD model of the 3D object to determine the dimensions, shape, and/or the axis of the object being 3D printed. The program 200 can receive the CAD model information through network communications 102 with a CAD program 202. The program 200 can analyze the CAD model of the 3D object to derive the information needed to 3D print the object to be 3D printed, herein referred to as the “3D object”. A user may select a CAD model from the client computing device 101 and/or database 130 for the program 200 to analyze. A user may be any person who is using the program 200.

At 304, the program 200 determines the type and quantity of pre-manufactured blocks 604 to use, herein referred to as “blocks”. Blocks 604 can be pre-manufactured and may be of various shapes and dimensions, such as cubical, rectangular, cylindrical, conical, triangular, etc. The program 200 can comprise an inventory of the available blocks 604 that may be used and the shape and dimensions of the available blocks 604. The program 200 can analyze the 3D object to be printed, inputted from CAD program 202, and can identify the quantity, shape, and dimensions of blocks 604 to use. The program 200 can identify various blocks 604 that are available to use and if the blocks 604 can be used to print the 3D object. If the 3D object is split into separate parts for printing, the program 200 may identify the blocks 604 that are to be used for printing each part of the 3D object. In some embodiments of the invention, the program 200 may print a 3D object directly on the baseplate 610 instead of on one or more blocks 604.

At 306, the program 200 determines if multiple 3D printers 252 will be used to 3D print the 3D object. The program 200 may perform a digital twin simulation of the 3D object and the split baseplate with multiple 3D printing nozzles 600. The program 200 may perform a digital twin simulation to determine if the 3D object may be printed in multiple parts and put together when all the parts of the 3D object are printed. A digital twin simulation can be a virtual representation of an object or system and is updated from real-time data and may use simulations to help decision-making. Digital twin simulation may be performed using artificial intelligence systems such as Maximo® (Maximo® and all Maximo®-based trademarks and logos are trademarks or registered trademarks of International Business Machines Corporation, and/or its affiliates). Additionally, multiple 3D printers 252 can be used to print the 3D object if more than one filament is being used to print the 3D object. In some embodiments of the invention, more than one 3D printer 252 may be used to print a 3D object. More than one 3D printer may share a common baseplate 610. Each 3D printer 252 may be attached at a different position to the baseplate 610. The program 200 can analyze the 3D object to be printed and may identify if the 3D object may be printed in parts using more than one 3D printer 252. According to one implementation, if the program 200 determines that multiple 3D printers 252 will be used (step 306, “YES” branch), the program 200 may continue to step 308 to assign a 3D object printing job to each 3D printer 252. If the program 200 determines that only one 3D printer 252 will be used (step 310, “NO” branch), the program 200 may continue to step 310 to obtain the exact position(s) of the pre-manufactured block(s) 604 using a 3D scanner 254.

At 308, the program 200 assigns a 3D object printing job to each 3D printer 252. If the 3D object may be printed using more than one 3D printer 252, the program 200 can split the 3D object into separate parts to be printed, and assign the printing of each part, also referred to as a “printing job”, to any of the 3D printers 252. A printing job may comprise instructions on what portion(s) of the 3D object a 3D printer 252 will be 3D printing. A printing job may comprise a set of steps, including the blocks 604 and the arraignments of the blocks 604 that will be used to print and printing information relating to the part and/or parts of the 3D object that the 3D printer will be printing. The 3D printers 252 may print at the same time and/or at different times, allowing for a parallel printing ecosystem.

At 310, the program 200 obtains the exact relative positions of the one or more blocks 604 on the baseplate. The program 200 can obtain the exact position of the blocks 604 using one or more 3D scanners 254 and/or the one or more 3D printers 252. If the program 200 determines that a block 604 is not precisely aligned on the baseplate 610, the program 200 can use the array of wheels 602 to move the block 604 into the correct position on the baseplate 610.

At 312, the program 200 prints the 3D object and/or part(s) of the 3D object. The program 200 may feed the data representing the 3D object to the one or more 3D printers 252 with instructions instructing the one or more 3D printers 252 on how to print the 3D object or part(s) of the 3D object.

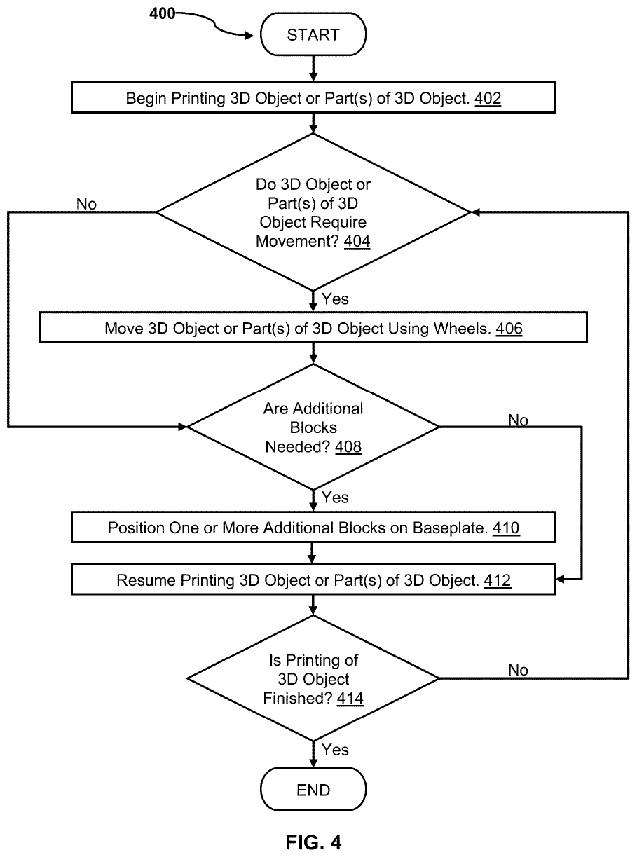

Referring now to FIG. 4, an operational flowchart illustrating a 3D printing process 400 is depicted according to at least one embodiment. At 402, the program 200 begins printing the 3D object and/or part(s) of the 3D object.

At 404, the program 200 determines if one or more of the 3D object and/or part(s) of the 3D object requires movement. The program 200 may comprise a. According to one implementation, if the program 200 determines that one or more of the 3D object and/or part(s) of the 3D object requires movement (step 404, “YES” branch), the program 200 may continue to step 406 to move the 3D object and/or part(s) of the 3D object using the wheels 602 on the baseplate 610. If the program 200 determines that the 3D object and part(s) of the 3D object do not require movement (step 404, “NO” branch), the program 200 may continue to step 408 to determine if additional blocks 604 are needed.

At 406, the program 200 moves the 3D object and/or part(s) of the 3D printed object using the array of wheels 602 in the baseplate 610. The program 200 can transport pre-manufactured blocks 604 and/or 3D objects along the baseplate 610, allowing pre-manufactured blocks 604 and/or 3D objects to be positioned under multiple 3D printing nozzles 608. Once a 3D printer has completed a printing job, the array of wheels 602 in the baseplate 610 may move one or more of the parts of the 3D object to another part of the baseplate 610.

At 408, the program 200 determines if additional blocks 604 are needed. The program 200 may track the printing progress of a 3D object while 3D printing is in progress and may determine if additional blocks 604 are needed to complete the printing of the 3D object. According to one implementation, if the program 200 determines that additional blocks 604 are needed (step 408, “YES” branch), the program 200 may continue to step 410 to position the one or more additional blocks 604 on the baseplate 610. If the program 200 determines that additional blocks 604 are not needed (step 408, “NO” branch), the program 200 may continue to step 412 to resume printing the 3D object and/or part(s) of the 3D object.

At 410, the program 200 positions one or more additional blocks 604 on the baseplate 610. The program 200 can position the one or more additional blocks 604 on the baseplate 610 using the array of wheels 602. The program 200 can obtain the exact relative positions of the one or more additional blocks 604 on the baseplate 610. The program 200 can obtain the exact position of the additional blocks 604 using one or more 3D scanners 254 and/or the one or more 3D printers 252. If the program 200 determines that an additional block 604 is not precisely aligned on the baseplate 610, the program 200 can use the array of wheels 602 to move the additional block 604 into the correct position on the baseplate 610.

At 412, the program 200 resumes printing the 3D object and/or part(s) of the 3D object. The program 200 can resume printing the 3D object and/or part(s) of the 3D object when it determines both that additional blocks 604 are not needed and if needed, that the one or more additional blocks 604 are positioned correctly on the baseplate 610 using object recognition with the 3D printer 252 and/or the 3D scanner 254.

At 414, the program 200 determines if the 3D object is finished being printed. The program 200 may track the printing progress of a 3D object while 3D printing is in progress and may identify the level of completion of the 3D object. The program 200 may identify the level of completion of the 3D object using object recognition with the 3D printer(s) 252 and/or the 3D scanner(s) 254. According to one implementation, if the program 200 determines that the 3D object is finished being 3D printed (step 414, “YES” branch), the program 200 may terminate. If the program 200 determines that the 3D object is not finished being 3D printed (step 414, “NO” branch), the program 200 may continue to step 404 to determine if one or more of the 3D object and/or part(s) of the 3D object requires movement.

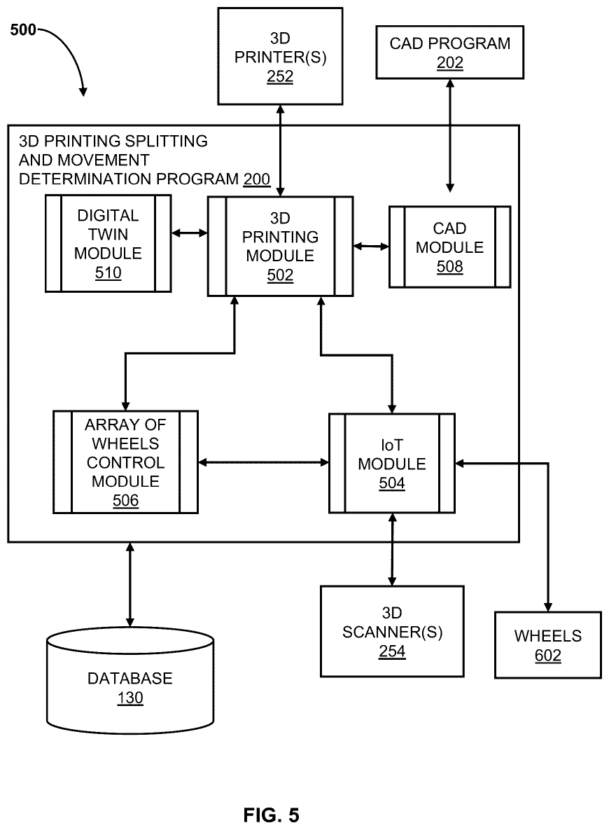

Referring now to FIG. 5, a system diagram illustrating an exemplary program environment 500 of an implementation of a 3D printing splitting and movement determination process 300 is depicted according to at least one embodiment. Here, the program 200 comprises a 3D printing module 502, an IoT module 504, an array of wheels control module 506, a CAD module 508, and a digital twin module 510. The exemplary program environment 500 details the interactions between the 3D printing module 502 and the IoT module 504, the 3D printing module 502 and the array of wheels control module 506, the 3D printing module 502 and the CAD module 508, the 3D printing module 502 and the digital twin module 510, and the IoT module 504 and the array of wheels control module 506. Additionally, the exemplary program environment 500 details the interactions between the 3D printing module 502 and the 3D printer(s) 252, the IoT module 504 and the 3D scanner(s) 254, the IoT module 504 and the wheels 602, the CAD module and the CAD program 202, and the program 200 and the database 130.

The 3D printing module 502 may be used to communicate with the 3D printer(s) 252. The IoT module 504 may be used to communicate with the 3D scanner(s) 254 and the array of wheels 602. The array of wheels control module may be used to control the movements of the array of wheels 602 on the baseplate 610. The CAD module 508 may be used to communicate with the CAD program 202. The digital twin module 510 may be used to perform a twin simulation of a 3D object.

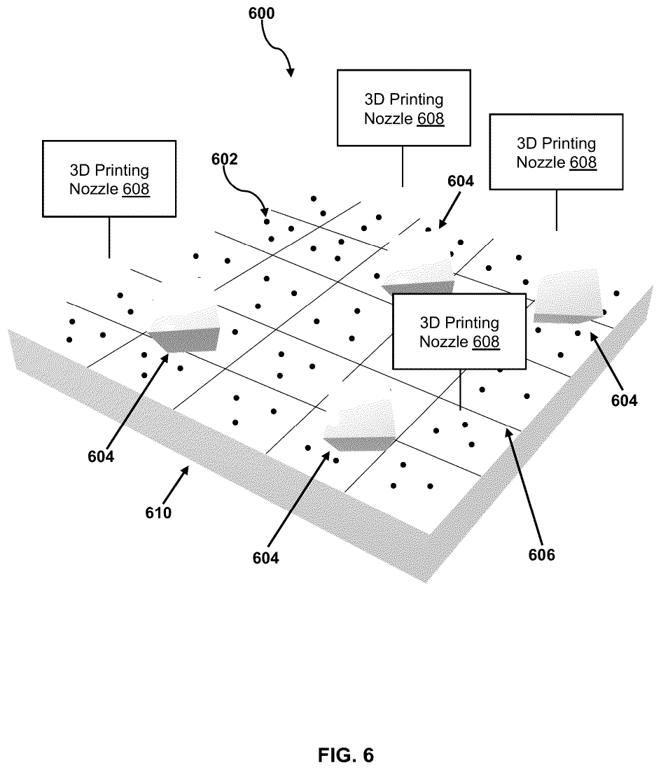

Referring now to FIG. 6, a split baseplate with multiple 3D printing nozzles 600 is depicted according to at least one embodiment. The split baseplate with multiple 3D printing nozzles 600 may comprise an array of wheels 602, one or more pre-manufactured blocks 604, baseplate panels 606, and one or more 3D printing nozzle 608, and a baseplate 610. The baseplate 610 may be split into multiple baseplate panels 606. Each panel may have several wheels 602. A 3D printing nozzle 608 may comprise a 3D printing material, such as a mixture of polylactic acid, “PLA”, and carbon fiber, a heat sink, one or more guide pulleys, a guide pipe, a heater, and a nozzle.

It may be appreciated that FIGS. 2 through 6 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for 3D printing, the method comprising:
arranging and manipulating an array of wheels on a baseplate;
analyzing shape and/or dimensions of an object to be 3D printed;
determining an arrangement of one or more blocks on which to print the object to be 3D printed based on the analyzing of the shape and/or dimensions of the object to be 3D printed;
positioning, using the array of wheels, the one or more bocks into the determined arrangement; and
printing a 3D object onto the one or more arranged blocks.

2. The method of claim 1, further comprising:
creating a parallel printing ecosystem.

3. The method of claim 2, wherein creating the parallel printing ecosystem comprises splitting up the object to be 3D printed into split parts, assigning split parts of the object to be 3D printed to at least one 3D printer, and printing the split parts of the object to be 3D printed onto the arranged blocks using the at least one 3D printer.

4. The method of claim 3, further comprising:
moving at least one printed split part of the 3D object and/or the 3D object, using the array of wheels, to a different location on the baseplate;
identifying level of printing progress of the 3D object; and
determining if additional one or more blocks are needed to finish printing the 3D object.

5. The method of claim 1, further comprising:
identifying level of printing progress of the 3D object; and
determining if at least one additional block is needed to finish printing the 3D object.

6. The method of claim 5, further comprising:
moving the at least one additional block to its correct position on the baseplate based on if the at least one additional block is determined to be needed to finish printing the 3D object.

7. The method of claim 1, further comprising:
using at least one 3D printing nozzle to print the 3D object, wherein each 3D printing nozzle may contain the same and/or a different type of filament.

8. A computer system for 3D printing, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
arranging and manipulating an array of wheels on a baseplate;
analyzing shape and/or dimensions of an object to be 3D printed;
determining an arrangement of one or more blocks on which to print the object to be 3D printed based on the analyzing of the shape and/or dimensions of the object to be 3D printed;
positioning, using the array of wheels, the one or more blocks into the determined arrangement; and
printing the object to be 3D printed onto the one or more arranged blocks.

9. The computer system of claim 8, further comprising:
creating a parallel printing ecosystem.

10. The computer system of claim 9, wherein creating the parallel printing ecosystem comprises splitting up the object to be 3D printed into split parts, assigning split parts of the object to be 3D printed to at least one 3D printer, and printing the split parts of the object to be 3D printed onto the one or more arranged blocks using the at least one 3D printer.

11. The computer system of claim 10, further comprising:
moving at least one printed split part of the 3D object and/or the 3D object, using the array of wheels, to a different location on the baseplate;
identifying level of printing progress of the 3D object; and
determining if additional one or more blocks are needed to finish printing the 3D object.

12. The computer system of claim 8, further comprising:
identifying level of printing progress of the 3D object; and
determining if at least one additional block is needed to finish printing the 3D object.

13. The computer system of claim 12, further comprising:
moving the at least one additional block to its correct position on the baseplate based on if the at least one additional block is determined to be needed to finish printing the 3D object.

14. The computer system of claim 8, further comprising:
using at least one 3D printing nozzle to print the 3D object, wherein each 3D printing nozzle may contain the same and/or a different type of filament.

15. A computer program product for 3D printing, the computer program product comprising:
one or more computer-readable tangible storage medium and program instructions stored on at least one of the one or more tangible storage medium, the program instructions executable by a processor to cause the processor to perform a method comprising:
arranging and manipulating an array of wheels on a baseplate;
analyzing shape and/or dimensions of an object to be 3D printed;
determining an arrangement of one or more blocks on which to print the object to be 3D printed based on the analyzing of the shape and/or dimensions of the object to be 3D printed;
positioning, using the array of wheels, the one or more blocks into the determined arrangement; and
printing the object to be 3D printed onto the one or more arranged blocks.

16. The computer program product of claim 15, further comprising:
creating a parallel printing ecosystem.

17. The computer program product of claim 16, wherein creating the parallel printing ecosystem comprises splitting up the object to be 3D printed into split parts, assigning split parts of the object to be 3D printed to at least one 3D printer, and printing the split parts of the object to be 3D printed onto the one or more arranged blocks using the at least one 3D printer.

18. The computer program product of claim 17, further comprising:
moving at least one printed split part of the 3D object and/or the 3D object, using the array of wheels, to a different location on the baseplate;
identifying level of printing progress of the 3D object; and
determining if additional one or more blocks are needed to finish printing the 3D object.

19. The computer program product of claim 15, further comprising:
identifying level of printing progress of the 3D object; and
determining if at least one additional block is needed to finish printing the 3D object.

20. The computer program product of claim 19, further comprising:
moving the at least one additional block to its correct position on the baseplate based on if the at least one additional block is determined to be needed to finish printing the 3D object.
